(19) United States
(12) Patent Application Publication
(10) Pub. No.: US 2021/0279286 A1
(43) Pub. Date: Sep. 9, 2021

(54) AUTO-COMPLETE RECIPIENT

(71) Applicant: International Business Machines Corporation, Armonk, NY (US)

(72) Inventors: KYLE D. ROBESON, North York (CA); ANTHONY DI LORETO, Markham (CA); BEN Z. AKSELROD, Givat Shmuel (IL); STEVE MCDUFF, Unionville (CA)

(21) Appl. No.: 16/809,655

(22) Filed: Mar. 5, 2020

(51) Int. Cl. G06F 16/9032; G06F 16/903; H04L 12/58

(52) U.S. Cl. CPC G06F 16/90324; H04L 51/28; H04L 51/04; G06F 16/90344

(57) ABSTRACT

A part of an addressee for a communication by a user is received. A time the communication is being composed is determined. A recommendation of an addressee based, at least in part, on the part of an addressee, the time the communication is being created by the user, and determined addressee trends is determined. The recommendation of an addressee is provided to the user.

### BACKGROUND

The present invention relates generally to the field of communication software, and more particularly to auto-completing recipients contact information in a communication software.

Communication software, such as email programs or messaging programs, allows for the exchanging of messages between people using electronic devices. These messages, or communications, consist of a sender, the person sending the message, and the addressee, the person or persons who receive the message. Additionally, the message consists of a body of text that is going to be sent from the sender to the addressee.

Many communication software include an auto-complete feature when adding the addressee in the communication. Auto-complete features provide at least one suggestion for an addressee as the user inputs part of the addressee into the message.

### SUMMARY

Embodiments of the present invention include a method, computer program product, and system for providing a recommendation of an addressee. In one embodiment, a part of an addressee for a communication by a user is received. A time the communication is being composed is determined. A recommendation of an addressee based, at least in part, on the part of an addressee, the time the communication is being created by the user, and determined addressee trends is determined. The recommendation of an addressee is provided to the user.

### BRIEF DESCRIPTION OF THE DRAWINGS

FIG. 1 is a functional block diagram of a network computing environment, generally designated 100, suitable for operation of auto-complete program 112, in accordance with at least one embodiment of the invention.

FIG. 2 is a flow chart diagram depicting operational steps for auto-complete program 112, in accordance with at least one embodiment of the invention.

FIG. 3 is a flow chart diagram depicting operational steps for auto-complete program 112, in accordance with at least one embodiment of the invention.

FIG. 4 is a block diagram depicting components of a computer, generally designated 400, suitable for executing auto-complete program 112, in accordance with at least one embodiment of the invention.

### DETAILED DESCRIPTION

Auto-complete addresses in communication programs, for example email or messaging services, utilize information from address books and/or previous email history. Current auto-complete utilizes how often a user writes a communication to a particular addressee as a key indicator of what addressee to auto-complete or suggest. The problem the present invention addresses is that users compose communications to different addressees based on a number of other factors and the number of communications to an addressee is not a proper way to determine who to auto-complete or suggest as an addressee in a communication.

Embodiments of the present invention provide for determining trends and/or changing habits of a user and the addresses the user wants to include when composing a communication. Embodiments of the present invention provide for auto-complete features of an addressee in a communication based on previous trends or changing habits of the user and based on other supplemental data, including, but not limited to, time, day of the week, and/or holidays. Embodiments of the present invention recognize the need to determine addressee in auto-complete features of a communication not based on how often a user composes a communication to an addressee. Embodiments of the present invention provide for auto-complete features based on previous user history of communications.

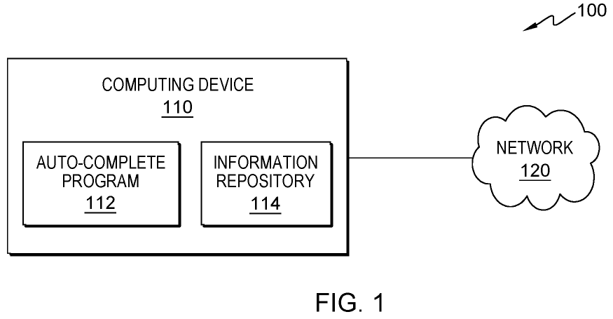

Referring now to various embodiments of the invention in more detail, FIG. 1 is a functional block diagram of a network computing environment, generally designated 100, suitable for operation of auto-complete program 112 in accordance with at least one embodiment of the invention. FIG. 1 provides only an illustration of one implementation and does not imply any limitation with regard to the environments in which different embodiments may be implemented. Many modifications to the depicted environment may be made by those skilled in the art without departing from the scope of the invention as recited by the claims.

Network computing environment 100 includes computing device 110 interconnected over network 120. In embodiments of the present invention, network 120 can be a telecommunications network, a local area network (LAN), a wide area network (WAN), such as the Internet, or a combination of the three, and can include wired, wireless, or fiber optic connections. Network 120 may include one or more wired and/or wireless networks that are capable of receiving and transmitting data, voice, and/or video signals, including multimedia signals that include voice, data, and video formation. In general, network 120 may be any combination of connections and protocols that will support communications between computing device 110 and other computing devices (not shown) within network computing environment 100.

Computing device 110 is a computing device that can be a laptop computer, tablet computer, netbook computer, personal computer (PC), a desktop computer, a personal digital assistant (PDA), a smartphone, smartwatch, or any programmable electronic device capable of receiving, sending, and processing data. In general, computing device 110 represents any programmable electronic devices or combination of programmable electronic devices capable of executing machine readable program instructions and communicating with other computing devices (not shown) within network computing environment 100 via a network, such as network 120.

In various embodiments of the invention, computing device 110 may be a computing device that can be a standalone device, a management server, a web server, a media server, a mobile computing device, or any other programmable electronic device or computing system capable of receiving, sending, and processing data. In other embodiments, computing device 110 represents a server computing system utilizing multiple computers as a server system, such as in a cloud computing environment. In an embodiment, computing device 110 represents a computing system utilizing clustered computers and components (e.g. database server computers, application server computers, web servers, and media servers) that act as a single pool of seamless resources when accessed within network computing environment 100.

In various embodiments of the invention, computing device 110 includes auto-complete program 112 and information repository 114.

In an embodiment, computing device 110 includes user interface (not shown). A user interface is a program that provides an interface between a user and an application. A user interface refers to the information (such as graphic, text, and sound) a program presents to a user and the control sequences the user employs to control the program. There are many types of user interfaces. In one embodiment, a user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In an embodiment, computing device 110 includes auto-complete program 112. Embodiments of the present invention provide for an auto-complete program 112 that gathers data to determine trends and changing habits. In embodiments of the present invention, auto-complete program 112 receives data from a number of previous communications. In embodiments of the present invention, auto-complete program 112 determines supplemental data associated with each communication, such as, but not limited to, sender, addressee(s), time of day of communication, day of the week of communication, if the communication was on a holiday, affiliation of communication (company vs. personal), etc. In embodiments of the present invention, auto-complete program 112 determines if trends exist for the communications. Embodiments of the present invention provide for an auto-complete program 112 that receives at least a part of an addressee and provides a recommended addressee based on the determined trends and changing habits. In embodiments of the present invention, auto-complete program 112 receives an indication a communication is being composed. In embodiments of the present invention, auto-complete program 112 determines the current time. In embodiments of the present invention, auto-complete program 112 receives at least a part of an addressee for the communication being composed. In embodiments of the present invention, auto-complete program 112 provides a recommended addressee based on the received at least part of the addressee, the determined time, and the determined trends and changing habits.

In an embodiment, computing device 110 includes information repository 114. In an embodiment, information repository 114 may be managed by auto-complete program 112. In an alternative embodiment, information repository 114 may be managed by the operating system of computing device 110, another program (not shown), alone, or together with, auto-complete program 112. Information repository 114 is a data repository that can store, gather, and/or analyze information. In some embodiments, information repository 114 is located externally to computing device 110 and accessed through a communication network, such as network 120. In some embodiments, information repository 114 is stored on computing device 110. In some embodiments, information repository 114 may reside on another computing device (not shown), provided information repository 114 is accessible by computing device 110. Information repository 114 may include, but is not limited to, supplemental data associated with communications, such as, but not limited to, sender, addressee(s), time of day of communication, day of the week of communication, if the communication was on a holiday, affiliation of communication (company vs. personal), etc. Additionally, information repository 114 may include, but is not limited to, determined trends and/or changing habit for addresses being used for communications based on the supplemental data associated with communications. Additionally, information repository 114 may include, but is not limited to one or more calendars which may be calendars that indicate holidays (national, religious, etc.) or a personal calendar that indicates specific holidays associated with a user. In an embodiment, the personal calendar may include, but is not limited to, appointments (e.g. doctor, dentist, etc.), meetings (e.g., school board meeting, planning board meeting, lunch meeting with friends, etc.), events (e.g., sports practice, sports game, concerts, etc.), special events (e.g., family visiting from out of town, going on vacation, etc.).

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, information repository 114 may be implemented with any suitable storage architecture known in the art, such as a relational database, an object-oriented database, or one or more tables.

As referred to herein, all data retrieved, collected, and used, is used in an opt in manner, i.e., the data provider has given permission for the data to be used. For example, the receive data regarding communications may include an option that must be selected by any number of users to allow the auto-complete program 112 to capture and save data associated with any number of communications. As another example, the auto-complete program 112 could request access to any number of communications within a communication services (email, text message, phone calls, etc.) and individuals may allow auto-complete program 112 access to communication data. Any data or information used for which the provider has not opted in is data that is publicly available.

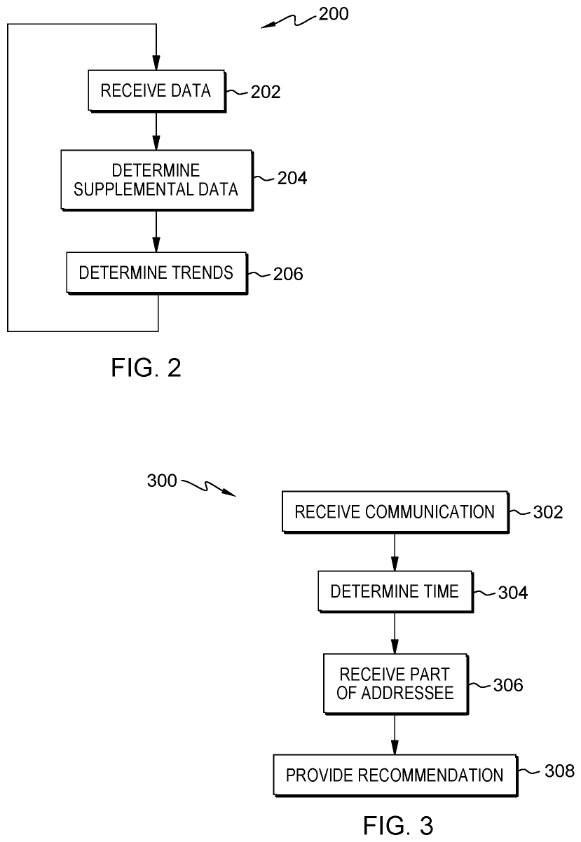

FIG. 2 is a flow chart diagram of workflow 200 depicting operational steps for auto-complete program 112 in accordance with at least one embodiment of the invention. In an alternative embodiment, the steps of workflow 200 may be performed by any other program while working with auto-complete program 112. It should be appreciated that embodiments of the present invention provide at least for determining trends or changing habits of addressees in communications. However, FIG. 2 provides only an illustration of one implementation and does not imply any limitations with regard to the environments in which different embodiments may be implemented. Many modifications to the depicted environment may be made by those skilled in the art without departing from the scope of the invention as recited by the claims. In a preferred embodiment, a user, via a user interface (not shown), can invoke workflow 200 upon a user wanting auto-complete program 112 to determine trends or changing habits of addresses in communications.

Auto-complete program 112 receives data (step 202). At step 202, auto-complete program 112 receives data about a number of communications. In an embodiment, auto-complete program 112 receives data about a number of communications from a single communication client, for example an email program (not shown). In an alternative embodiment, auto-complete program 112 receives data about a number of communications from multiple communication clients, for example an email program (not shown) and a messaging client (not shown). In an embodiment, the communications may be related to just a single user, such as the user of computing device 110. In an alternative embodiment, the communications may be related to more than one user, such as a number of users of an email program (not shown). In an embodiment, auto-complete program 112 may receive a number of communications in single data set in order to analyze. In an alternative embodiment, auto-complete program 112 may continually receive update communications in order to continually update trends and/or changing habits of the addressees being used based on the supplemental data.

Auto-complete program 112 determines supplemental data (step 204). At step 204, auto-complete program 112 determines supplemental data for communications received in step 202. In an embodiment, auto-complete program 112 may determine the supplemental data for the communications based on metadata found in the communication and/or based on calendars in information repository 114. In an embodiment, supplemental information may include, but is not limited to, supplemental data associated with communications, such as, but not limited to, sender, addressee(s), date of the communication, time of day of communication, day of the week of communication, if the communication was on a holiday, affiliation of communication (company vs. personal), etc. In a first example, auto-complete program 112 may determine the time of communications to addressee A and addressee B. In a second example, auto-complete program 112 may determine the date of communication to addressee A and determine that the date of the communication is a national holiday. In a third example, auto-complete program may determine the data of communication to addressee B and determine that the date of the communication is a personal holiday, for example a birthday of the addressee or birthday of the sender.

Auto-complete program 112 determines trends (step 206). At step 206, auto-complete program 112 determines trends and/or changing habits of the addressees being used based on the supplemental data. In other words, auto-complete program 112, reviews the addressees that are being used in the communications and determines correlations, trends, and/or habits of the supplemental data based on the addressees being used. For example, a user may write one or more communications to addressee “JohnSmith@mail.com” and the supplemental data for those communications indicates the communications were on Monday, Wednesday or Friday, and a user may write one or more commutations to addressee “JohnJones@mail.com” and the supplemental data for those communications indicates the communications were on Tuesday or Thursday. In this example, auto-complete program 112 determines the user writes communications to the first addressee on Monday, Wednesday and Friday, and to the second addressee on Tuesday and Thursday, and on the weekend both addresses are equally weighted. In a second example, a user may write one or more communications to addressee “SteveSmith@mail.com”, that is an addressee of a coworker, and the supplemental data for those communications indicates the communications were between 9 AM and 3 PM, a user may write one or more commutations to addressee “SteveJones@mail.com”, that is an addressee of a friend, and the supplemental data for those communications indicates the communications were between 3 PM and 11 PM, a user may write one or more communications to addressee “SarahSmith@mail.com”, that is an addressee of a family member, and the supplemental data for those communications indicates the communications were between 6 AM and 9 AM. In this example, auto-complete program 112 may determine the user composes emails to addressee that are family members between 6 AM and 9 AM, addressees that are coworkers between 9 AM and 3 PM, and addresses that are friends between 3 PM and 11 PM.

FIG. 3 is a flow chart diagram of workflow 300 depicting operational steps for auto-complete program 112 in accordance with at least one embodiment of the invention. In an alternative embodiment, the steps of workflow 300 may be performed by any other program while working with auto-complete program 112. It should be appreciated that embodiments of the present invention provide at least for providing a recommended addressee. However, FIG. 3 provides only an illustration of one implementation and does not imply any limitations with regard to the environments in which different embodiments may be implemented. Many modifications to the depicted environment may be made by those skilled in the art without departing from the scope of the invention as recited by the claims. In a preferred embodiment, a user, via a user interface (not shown), can invoke workflow 300 upon a user wanting auto-complete program 112 to use part of an addressee in a communication and to provide a recommendation of an addressee.

Auto-complete program 112 receives communication (step 302). At step 302, auto-complete program 112 receives an indication a user is composing a new communication. In other words, auto-complete program 112 receives an indication from another program (not shown), such as an email program or messaging program, that a user has initiated composing a message in the email or messaging program.

Auto-complete program 112 determines the time (step 304). At step 304, auto-complete program 112 determines the time the indication of step 302 was received. In an embodiment, the time may include time of day, for example, 7:02 AM or 3:05 PM. In an alternative embodiment, the time may include a day of the week, for example, Monday or Saturday. In an alternative embodiment, the time may include a date, for example, January 4^{th} or July 4^{th}, and in this embodiment, auto-complete program 112 may compare the determined date to the calendars found in information repository 114 to determine if the date is a holiday or any other significant day that is not an ordinary day of the week. For example, if the date is July 4^{th}, auto-complete program 112 may determine this is a holiday in the United States. In another example, if the data is January 4^{th}, auto-complete program 112 may determine that this is the birthday of the user.

Auto-complete program 112 receives part of addressee (step 306). At step 306, auto-complete program 112 receives a part of an addressee in the communication that is being composed in step 302. In other words, auto-complete program 112, as the user is typing in an addressee in the communication being composed, receives the data being typed that is the addressee. In a first embodiment, the part of the addressee may be the beginning of the addressee. In an alternative embodiment, the part of the addressee may be any part of the addressee. For example, auto-complete program 112 receives a part of the addressee from communication program (not shown) that states “Smith”. In another example, auto-complete program 112 receives a part of the addressee from communication program (not shown) that states “Joh”. In an embodiment, auto-complete program 112 may receive part of the addressee and proceed to step 308, however, auto-complete program 112 may receive more parts of the addressee and then update the received part of addressee before proceeding to step 308.

Auto-complete program 112 provides a recommendation (step 308). At step 308, auto-complete program 112 uses the trends and changing habits determined using workflow 200 and provides at least one recommendation of an addressee based on determined time of step 304 and the received part of addressee of step 306. In an embodiment, auto-complete program 112 provides a single addressee as the recommendation. In an alternative embodiment, auto-complete program 112 will provide more than one addressee as the recommendation. In an embodiment, auto-complete program 112 may receive updated parts of addressee and then reperform step 308 at any time. In an embodiment, the recommendation is provided in user interface of the communication software (not shown), such as an email program or messaging service. For example, as discussed in step S206 of workflow 200, trends and/or changing habits were determined. Continuing these examples, auto-complete program 112 may receive “John” as the at least part of the addressee. In this example, auto-complete program 112 determines that it is Monday, and therefore auto-complete program 112 provides “JohnSmith@mail.com” as the recommendation for an addressee. However, in this example, if auto-complete program 112 determines that it is Tuesday, auto-complete program 112 would provide “JohnJones@mail.com” as the recommendation for an addressee.

In another example continued from step S206 of workflow 200, auto-complete program 112 may receive “S” as the at least part of the addressee. In this example, auto-complete program 112 determines that it is LOAM. Therefore, auto-complete program 112 provides three recommendation. The first recommendation, “SteveSmith@mail.com”, is the indicated as the highest recommended addressee due to the time being LOAM and the previously determined trend is that this addressee is emailed between 9 AM and 3 PM. In an embodiment, the highest recommended addressee may be indicated as being placed on “top” of other addressee on the user-interface of the communication program (not shown) so as to indicate the first possible choice. Alternatively, the highest recommended addressee may be indicated with bold, underline, or increase font size. Continuing this example, the second recommendation, “SarahSmith@mail.com”, is indicated as the second highest recommended addressee due to the time being LOAM and the next closest time slot in the determined trends for an addressee is between 6 AM to 9 AM. In an embodiment, the second recommended addressee may be indicated directly below the highest recommended addressee in the user interface of the communication program (not shown). Finishing this example, “SteveJones@mail.com”, is indicated as the third highest recommended addressee due to the time being LOAM and the final closest time slot in the determined trends for an addressee is between 3 PM and 11 PM. In an embodiment, the third recommended addressee may be indicated at the bottom of the recommended addressees in the user interface of the communication program (not shown).

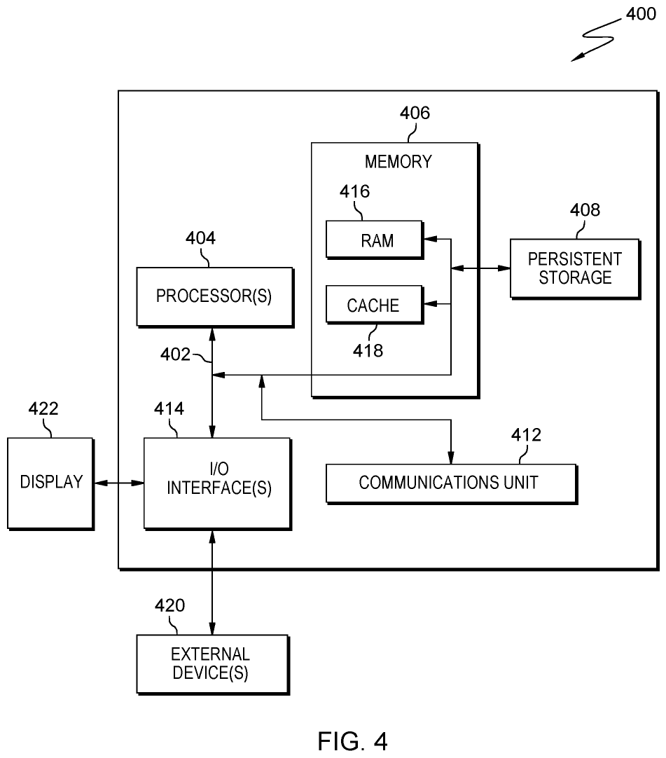

FIG. 4 is a block diagram depicting components of a computer 400 suitable for auto-complete program 112, in accordance with at least one embodiment of the invention. FIG. 4 displays the computer 400, one or more processor(s) 404 (including one or more computer processors), a communications fabric 402, a memory 406 including, a RAM 416, and a cache 418, a persistent storage 408, a communications unit 412, I/O interfaces 414, a display 422, and external devices 420. It should be appreciated that FIG. 4 provides only an illustration of one embodiment and does not imply any limitations with regard to the environments in which different embodiments may be implemented. Many modifications to the depicted environment may be made.

As depicted, the computer 400 operates over the communications fabric 402, which provides communications between the computer processor(s) 404, memory 406, persistent storage 408, communications unit 412, and input/output (I/O) interface(s) 414. The communications fabric 402 may be implemented with an architecture suitable for passing data or control information between the processors 404 (e.g., microprocessors, communications processors, and network processors), the memory 406, the external devices 420, and any other hardware components within a system. For example, the communications fabric 402 may be implemented with one or more buses.

The memory 406 and persistent storage 408 are computer readable storage media. In the depicted embodiment, the memory 406 comprises a random-access memory (RAM) 416 and a cache 418. In general, the memory 406 may comprise any suitable volatile or non-volatile one or more computer readable storage media.

Program instructions auto-complete program 112 may be stored in the persistent storage 408, or more generally, any computer readable storage media, for execution by one or more of the respective computer processors 404 via one or more memories of the memory 406. The persistent storage 408 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by the persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of the persistent storage 408.

The communications unit 412, in these examples, provides for communications with other data processing systems or devices. In these examples, the communications unit 412 may comprise one or more network interface cards. The communications unit 412 may provide communications through the use of either or both physical and wireless communications links. In the context of some embodiments of the present invention, the source of the various input data may be physically remote to the computer 400 such that the input data may be received, and the output similarly transmitted via the communications unit 412.

The I/O interface(s) 414 allow for input and output of data with other devices that may operate in conjunction with the computer 400. For example, the I/O interface 414 may provide a connection to the external devices 420, which may be as a keyboard, keypad, a touch screen, or other suitable input devices. External devices 420 may also include portable computer readable storage media, for example thumb drives, portable optical or magnetic disks, and memory cards. Software and data used to practice embodiments of the present invention may be stored on such portable computer readable storage media and may be loaded onto the persistent storage 408 via the I/O interface(s) 414. The I/O interface(s) 414 may similarly connect to a display 422. The display 422 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider). In some embodiments, electronic circuitry including, for example programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram blocks or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing form the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for providing a recommendation of an addressee, the computer-implemented method comprising:
receiving, by one or more computer processors, a part of an addressee for a communication created by a user;
determining, by one or more computer processors, a time the communication is being composed;
determining, by one or more computer processors, a recommendation of an addressee based, at least in part, on of the part of an addressee, the time the communication is being created by the user, and determined addressee trends; and
providing, by one or more computer processors, the recommendation of an addressee to the user.

2. The computer-implemented method of claim 1, wherein the determined addressee trends are determined comprises:
determining, by one or more computer processors, one or more communications, wherein the one or more communications previously sent;
determining, by one or more computer processors, one or more supplemental data for each communication of the one or more communications;
determining, by one or more computer processors, addressee trends based on the one or more supplemental data.

3. The computer-implemented method of claim 2, wherein the one or more communications are composed by the user.

4. The computer-implemented method of claim 2, wherein the one or more supplemental data is selected from the group consisting of sender of a communication, addressee(s) of the communication, date of the communication, time of day of the communication, day of the week of the communication, if the communication was on a holiday, and affiliation of the communication.

5. The computer-implemented method of claim 2, wherein the one or more communications are from one or more clients.

6. The computer-implemented method of claim 2, wherein the determined addressee trends is based on the one or more supplemental data and one or more calendars.

7. The computer-implemented method of claim 6, wherein the one or more calendars is selected from the group consisting of holiday calendars and personal calendars.

8. A computer program product for providing a recommendation of an addressee, the computer program product comprising:
one or more computer readable storage media; and
program instructions stored on the one or more computer readable storage media, the program instructions comprising:
program instructions to receive a part of an addressee for a communication created by a user;
program instructions to determine a time the communication is being composed;
program instructions to determine a recommendation of an addressee based, at least in part, on of the part of an addressee, the time the communication is being created by the user, and determined addressee trends; and
program instructions to provide the recommendation of an addressee to the user.

9. The computer program product of claim 8, wherein the program instructions to determine addressee trends are determined comprise program instructions to:
determine one or more communications, wherein the one or more communications previously sent;
determine one or more supplemental data for each communication of the one or more communications;
determine addressee trends based on the one or more supplemental data.

10. The computer program product of claim 9, wherein the one or more communications are composed by the user.

11. The computer program product of claim 9, wherein the one or more supplemental data is selected from the group consisting of sender of a communication, addressee(s) of the communication, date of the communication, time of day of the communication, day of the week of the communication, if the communication was on a holiday, and affiliation of the communication.

12. The computer program product of claim 9, wherein the one or more communications are from one or more clients.

13. The computer program product of claim 9, wherein the determined addressee trends is based on the one or more supplemental data and one or more calendars.

14. The computer program product of claim 13, wherein the one or more calendars is selected from the group consisting of holiday calendars and personal calendars.

15. A computer system for providing a recommendation of an addressee, the computer system comprising:
one or more computer processors;
one or more computer readable storage media; and
program instructions, stored on the one or more computer readable storage media for execution by at least one of the one or more computer processors, the program instructions comprising:
program instructions to receive a part of an addressee for a communication created by a user;
program instructions to determine a time the communication is being composed;
program instructions to determine a recommendation of an addressee based, at least in part, on of the part of an addressee, the time the communication is being created by the user, and determined addressee trends; and
program instructions to provide the recommendation of an addressee to the user.

16. The computer system of claim 15, wherein the program instructions to determine addressee trends are determined comprise program instructions to:
determine one or more communications, wherein the one or more communications previously sent;
determine one or more supplemental data for each communication of the one or more communications;
determine addressee trends based on the one or more supplemental data.

17. The computer system of claim 16, wherein the one or more communications are composed by the user.

18. The computer system of claim 16, wherein the one or more supplemental data is selected from the group consisting of sender of a communication, addressee(s) of the communication, date of the communication, time of day of the communication, day of the week of the communication, if the communication was on a holiday, and affiliation of the communication.

19. The computer system of claim 16, wherein the one or more communications are from one or more clients.

20. The computer system of claim 16, wherein the determined addressee trends is based on the one or more supplemental data and one or more calendars.
